(19) United States
(12) Patent Application Publication
(10) Pub. No.: US 2022/0164438 A1
(43) Pub. Date: May 26, 2022

(54) INCIDENT SCENARIO GENERATION DEVICE AND INCIDENT SCENARIO GENERATION SYSTEM

(71) Applicant: Hitachi, Ltd., Tokyo (JP)

(72) Inventors: Tetsuro KITO, Tokyo (JP); Tomohiro SHIGEMOTO, Tokyo (JP)

(73) Assignee: Hitachi, Ltd., Tokyo (JP)

(21) Appl. No.: 17/617,668

(22) PCT Filed: Jun. 16, 2020
(86) PCT No.: PCT/JP2020/023641

§ 371 Date: Dec. 9, 2021

(30) Foreign Application Priority Data
Jun. 25, 2019 (JP) 2019-117704

(51) Int. Cl. G06F 21/55

(52) U.S. Cl. CPC G06F 21/552; G06F 2221/034

(57) ABSTRACT

Disclosed is an incident scenario generation device for generating an incident scenario that indicates how an attack progresses in relation to an information system. The incident scenario generation device includes an attack parts database for storing attack parts information and a system configuration database for storing system configuration information about the information system. The incident scenario generation device generates the incident scenario according to the attack parts information stored in the attack parts database and to the system configuration information stored in the system configuration database.

### TECHNICAL FIELD

The present invention relates to an incident scenario generation device and an incident scenario generation system.

### BACKGROUND ART

Cyber attacks are continuously evolving year after year since, for example, new vulnerabilities are found and new attack methods are created. Under such circumstances, organizations are seriously concerned about issues related to whether an information system is capable of defending against cyber attacks and how much damage will be caused by cyber attacks.

For generating an incident scenario that indicates how cyber attacks progress in relation to the information system, various means are available, for example, to perform a penetration test on an actual system and make risk assessment theoretically based on system configuration information.

However, all the above-mentioned means are manually implemented by experienced engineers. The penetration test is conducted by actually attacking the information system. Thus, the result of the penetration test is highly accurate. However, adequate analyses may not be made in the penetration test because it may adversely affect the information system. Further, the theoretical risk assessment requires a sufficient amount of time.

As described above, when an incident scenario is to be generated, it is difficult to make prompt or extensive analyses. A technology for solving such a problem is described, for example, in Patent Document 1. The technology described in Patent Document 1 is for predefining a basic attack scenario and generating individual attack scenarios suitable for a system configuration according to the predefined basic attack scenario.

### PRIOR ART DOCUMENT

### Patent Document

Patent Document 1: PCT Patent Publication No. WO 2017/12604

### SUMMARY OF THE INVENTION

### Problems to be Solved by the Invention

When the technology described in Patent Document 1 is used, it is necessary to predefine the basic attack scenario. Therefore, when creating a new scenario, it is necessary to manually create a basic scenario. Further, when, for example, a new attack method appears, a scenario based on the use of the new attack method cannot be generated without defining the new attack method as a basic scenario.

An object of the present invention is to automatically generate an incident scenario in an incident scenario generation device.

### Means for Solving the Problems

According to an aspect of the present invention, there is provided an incident scenario generation device that generates an incident scenario indicating how an attack progresses in relation to an information system. The incident scenario generation device includes a computation device and a storage device. The storage device has an attack parts database and a system configuration database. The attack parts database stores attack parts information. The system configuration database stores system configuration information about the information system. The computation device generates the incident scenario according to the attack parts information stored in the attack parts database and to the system configuration information stored in the system configuration database.

According to another aspect of the present invention, there is provided an incident scenario generation system that is formed by connecting, through a network, an incident scenario generation device, an attack parts database storage device, and a system configuration database storage device with each other. The attack parts database storage device stores an attack parts database for storing attack parts information. The system configuration database storage device stores a system configuration database for storing system configuration information about an information system. The incident scenario generation device generates an incident scenario according to the attack parts information stored in the attack parts database and to the system configuration information stored in the system configuration database. The incident scenario indicates how an attack progresses in relation to the information system.

At least one embodiment of a subject matter disclosed in this document will be described in detail in the accompanying drawings and in the rest of this document. Other features, aspects, and advantages of the disclosed subject matter will become apparent from the following disclosure, drawings, and appended claims.

### Advantage of the Invention

According to an aspect of the present invention, the incident scenario generation device is able to automatically generate an incident scenario.

### BRIEF DESCRIPTION OF THE DRAWINGS

FIG. 1 is a block diagram illustrating an example of a network system that includes an incident scenario generation device, a user terminal, and the Internet.

FIG. 2 is a block diagram illustrating an example of hardware in the incident scenario generation device.

FIG. 3 is a block diagram illustrating an example of a logical configuration of the incident scenario generation device.

FIG. 4 is a flowchart illustrating an example of processing performed by an incident scenario generation function.

FIG. 5 is a flowchart illustrating an example of a network reachable terminal acquisition process.

FIG. 6 is a flowchart illustrating an example of an attackable parts pickup process.

FIG. 7 is an explanatory diagram illustrating an example of an attack parts database (DB).

FIG. 8 is an explanatory diagram illustrating an example of a scenario DB.

FIG. 9 is an explanatory diagram illustrating an example of an equipment table in a system configuration DB.

FIG. 10 is an explanatory diagram illustrating an example of a network connection table in the system configuration DB.

FIG. 11 is an explanatory diagram illustrating an example of a network filter table in the system configuration DB.

FIG. 12 is an explanatory diagram illustrating an example of a screen of a scenario display function.

FIG. 13 is a diagram illustrating an example configuration of an incident scenario generation system.

### DESCRIPTION OF EMBODIMENTS

Embodiments of the present invention will now be described with reference to the accompanying drawings. It should be noted that the term “database” may be occasionally abbreviated to “DB” in the accompanying drawings and in this document.

### First Embodiment

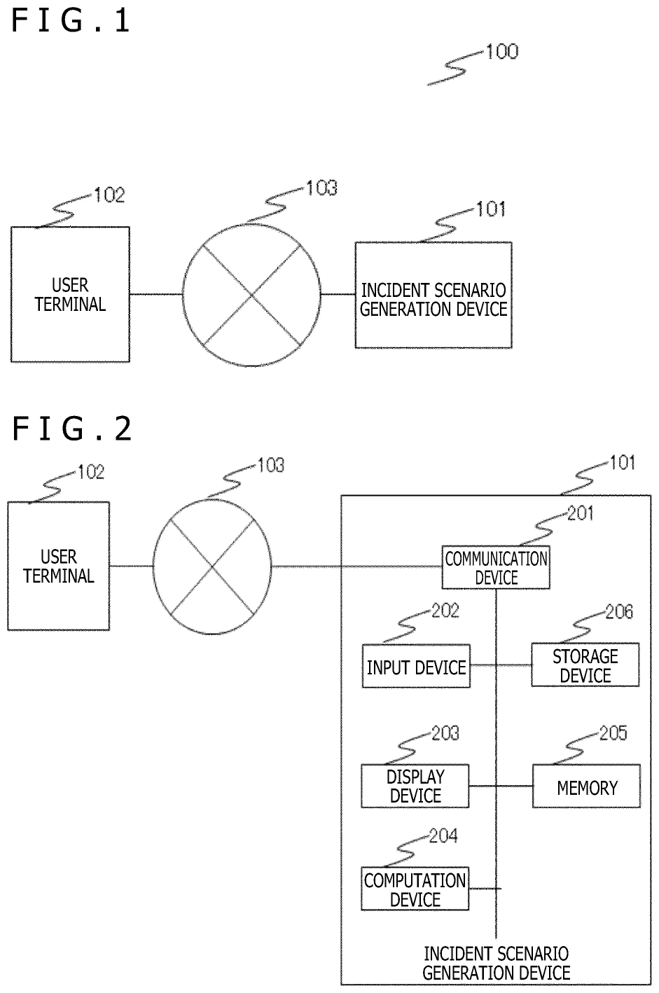

FIG. 1 is a block diagram illustrating a network system 100 that includes an incident scenario generation device 101, a user terminal 102, and a network 103. The network system 100 is configured such that the incident scenario generation device 101 and the user terminal 102 are connected to each other through the intranet 103. The user terminal 102 is used by employees of an organization. A plurality of user terminals 102 may exist in the network system 100. Further, although not depicted in FIG. 1, the network 103 may be connected, for example, to the other computer equipment and network devices in an organization operating the incident scenario generation device 101 and to computers used by an administrator managing the incident scenario generation device 101.

A hardware configuration of the incident scenario generation device 101 will now be described with reference to FIG. 2. The incident scenario generation device 101 includes a communication device 201, an input device 202, a display device 203, a computation device 204, a memory 205, and a storage device 206.

The communication device 201 is a network interface such as a network card. The communication device 201 receives data from another device through the network 103, and transmits the received data to the computation device 204. Subsequently, the communication device 201 transmits data generated by the computation device 204 to another device through the network 103.

The input device 202 is a keyboard, a mouse, or other similar device, and configured to receive information inputted by a user. The display device 203 is an LCD (Liquid Crystal Display) or other similar device, and configured to output information to the administrator.

The storage device 206 is a hard disk or other similar device, and configured to store, for example, programs to be executed by the computation device 204 and data to be used by the computation device 204. The memory 205 is a storage area from which, for example, data is temporarily read.

The computation device 204 executes the programs stored in the storage device 206 to control the other devices. The computation device 204 controls the input device 202 and the display device 203, receives data inputted from the input device 202, and outputs data to the display device 203. The programs stored in the storage device 206 are loaded into the memory 205 from the storage device 206 and executed in the memory 205 by the computation device 204.

The computation device 204 reads the programs from the storage device 206. However, as an alternative example, the computation device 204 may read the programs from an optical recording medium such as a CD or a DVD, a magneto-optical recording medium such as an MO, a tape medium, a magnetic recording medium, or other recording medium such as a semiconductor memory. Further, as another alternative example, the computation device 204 may read the programs from another device through a communication medium. The communication medium is a network or a digital signal or carrier wave that propagates the programs.

Furthermore, the programs may be stored in the storage device 206 from a storage device in an external device through a network or through a portable storage medium.

The hardware configuration of the user terminal 102 depicted in FIG. 1 is identical or equivalent to the hardware configuration of the incident scenario generation device 101 depicted in FIG. 2. Therefore, the hardware configuration of the user terminal 102 is not depicted.

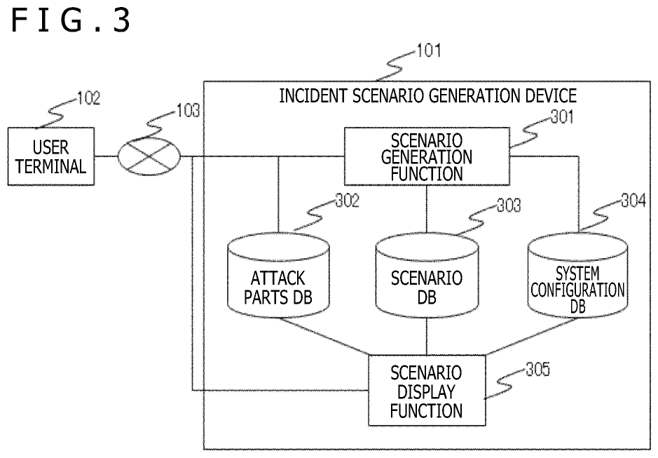

The logical configuration of the incident scenario generation device 101 will now be described with reference to FIG. 3. The incident scenario generation device 101 includes a scenario generation function 301, an attack parts DB 302, a scenario DB 303, a system configuration DB 304, and a scenario display function. The scenario generation function 301 receives an instruction from the user terminal 102, and performs an incident scenario generation process. The attack parts DB 302 is a database for storing attack parts that are incident scenario components. The scenario DB 303 is a database for storing incident scenarios generated by the scenario generation function 301.

The system configuration DB 304 is a database for storing system configuration information (an equipment table, a network connection table, and a network filter table) about an information system for which incident scenarios are to be generated. The scenario display function 305 receives an instruction from the user terminal 102, reads a generated incident scenario from the scenario DB 303, and returns data to be displayed on a screen of the user terminal 102.

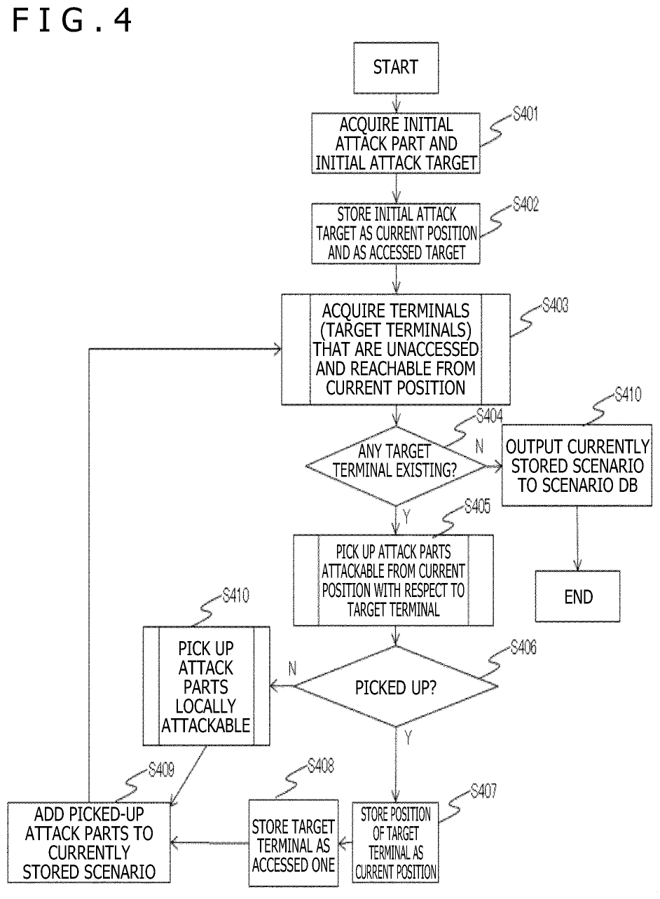

A process performed by the scenario generation function 301 will now be described with reference to the flowchart of FIG. 4. First of all, in step S401, the scenario generation function 301 acquires information about an initial attack part and an initial attack target. The information is given as an input according to an instruction from the user terminal 102. Alternatively, however, the scenario generation function 301 may acquire the information about the initial attack part and initial attack target by first accessing a local file system or a remote service.

Next, in step S402, the scenario generation function 301 stores the initial attack target as a current position and as an accessed target. The current position is information indicating computers that have been attacked in an incident scenario.

Next, in step S403, the scenario generation function 301 acquires information about terminals that are unaccessed and reachable from the current position. These terminals are hereinafter referred to as target terminals. Step S403 will be described in detail later.

Next, in step S404, the scenario generation function 301 checks the result obtained from step S403 to determine whether any target terminal exists. If a target terminal exists, the scenario generation function 301 proceeds to step S405, and picks up attack parts that are able to make an attack from the current position to the target terminal. Step S405 will be described in detail later. Upon completion of step S405, the scenario generation function 301 proceeds to step S406, and checks whether the attack parts have been picked up in step S405. If the attack parts have been picked up, the scenario generation function 301 proceeds to step S407, and stores the position of the target terminal as the current position. This signifies that the current attack has progressed to reach the target terminal.

Next, in step S408, the scenario generation function 301 stores the target terminal as an accessed one. Next, in step S409, the scenario generation function 301 adds the picked-up attack parts to the currently stored scenario. Upon completion of step S409, the scenario generation function 301 returns to step S403.

Meanwhile, if the attack parts have not been picked up in step S406, the scenario generation function 301 proceeds to step S410, and picks up attack parts that are able to make a local attack. Step S410 will be described in detail later. Upon completion of step S410, the scenario generation function 301 proceeds to step S409. If, in step S404, no target terminal exists, the scenario generation function 301 outputs the currently stored scenario to the scenario DB 303, and terminates the process.

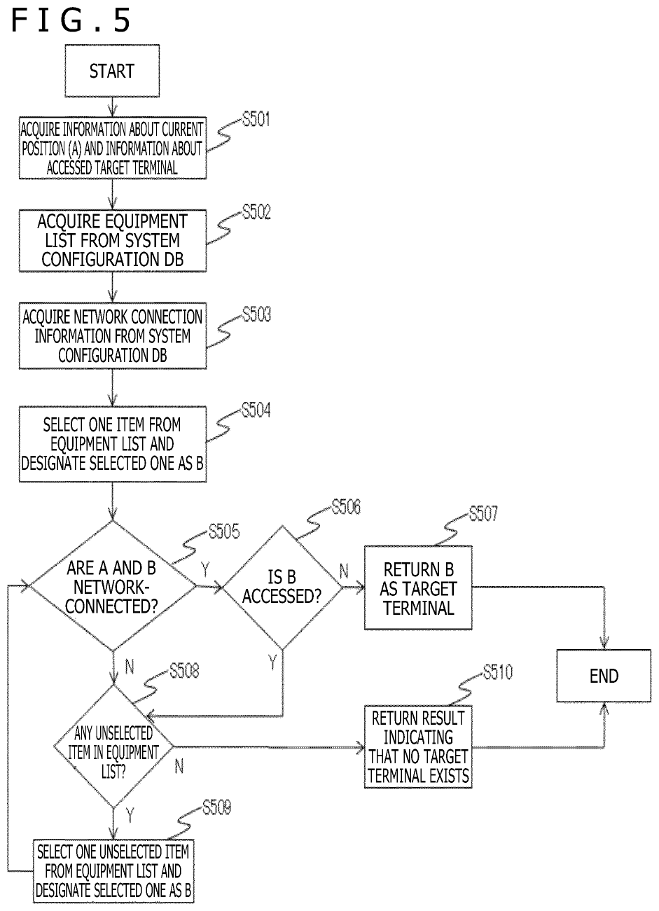

FIG. 5 is a flowchart illustrating a network reachable terminal acquisition process that is performed in step S403 of the flowchart depicting the scenario generation function 301 according to a first embodiment of the present invention. At the beginning of the process, in step S501, the scenario generation function 301 acquires information about the current position (hereinafter designated as A) and information about the accessed target terminal. Next, in step S502, the scenario generation function 301 acquires an equipment list from the system configuration DB 304.

Next, in step S503, the scenario generation function 301 acquires network connection information from the system configuration DB 304. Next, in step S504, the scenario generation function 301 selects one item from the equipment list. The selected item is hereinafter designated as B. Next, in step S505, the scenario generation function 301 checks whether A and B are network-connected. This check is performed by using the network connection information acquired in step S503. If the result obtained from step S505 indicates that A and B are network-connected. The scenario generation function 301 proceeds to step S506, and checks whether B is accessed.

If B is unaccessed, the scenario generation function 301 proceeds to step S507, returns B as a target terminal, and terminates the process. If, in step S505, A and B are not network-connected, or if, in step S506, B is already accessed, the scenario generation function 301 proceeds to step S508, and checks whether any unselected item is in the equipment list. If there is any unselected item in the equipment list, the scenario generation function 301 proceeds to step S509, selects one unselected item from the equipment list, designates the selected item as B, and returns to step S505. If, in step S508, there is no unselected item in the equipment list, the scenario generation function 301 proceeds to step S510, returns a result indicating that no target terminal exists, and terminates the process.

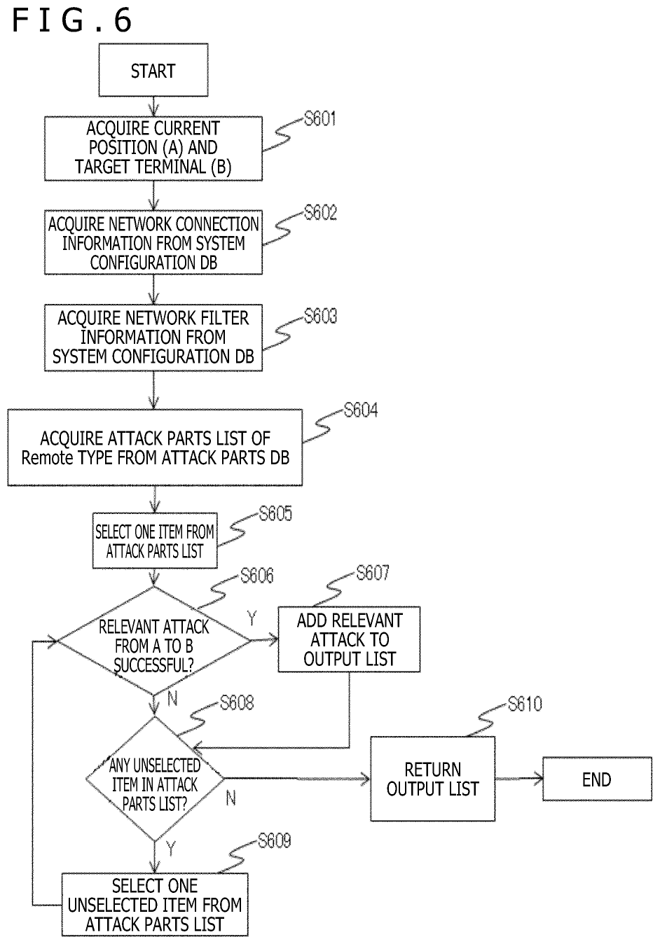

FIG. 6 is a flowchart illustrating an attackable parts pickup process that is performed in step S405 of the flowchart depicting the scenario generation function 301. First of all, in step S601, the scenario generation function 301 acquires information about the current position (hereinafter designated as A) and the target terminal (hereinafter designated as B). Next, in step S602, the scenario generation function 301 acquires the network connection information from the system configuration DB 304. Next, in step S603, the scenario generation function 301 acquires network filter information from the system configuration DB 304. Next, in step S604, the scenario generation function 301 acquires an attack parts list of a remote type from the attack parts DB 302. Next, in step S605, the scenario generation function 301 selects one item from the acquired attack parts list.

Next, in step S606, the scenario generation function 301 checks whether the attack will be successfully made from A to B. The attack will be successfully made in a case where the prerequisites for the attack are met and the description of the attack will not be filtered by the network. If the result of the check indicates that the attack will be successfully made, the scenario generation function 301 proceeds to step S607, and adds the attack to an output list. Next, in step S608, the scenario generation function 301 checks whether there is any unselected item in the attack parts list. If there is any unselected item in the attack parts list, the scenario generation function 301 proceeds to step S609, selects one unselected item from the attack parts list, and returns to step S606.

If the result of the check in step S606 indicates that the attack will not be successfully made, the scenario generation function 301 proceeds to step S608. If, in step S608, there is no unselected item in the attack parts list, the scenario generation function 301 proceeds to step S610, returns the output list, and terminates the process.

The attackable parts pickup process performed in step S410 of the flowchart depicting the scenario generation function 301 will not be depicted because it is similar to the flow of processing in step S405, which is depicted in FIG. 6. The attackable parts pickup process performed in step S410 differs from the one performed as depicted in FIG. 6 in that no network-related processing is required because A and B represent the same terminal, and that the attack acquired in step S604 is of a local type.

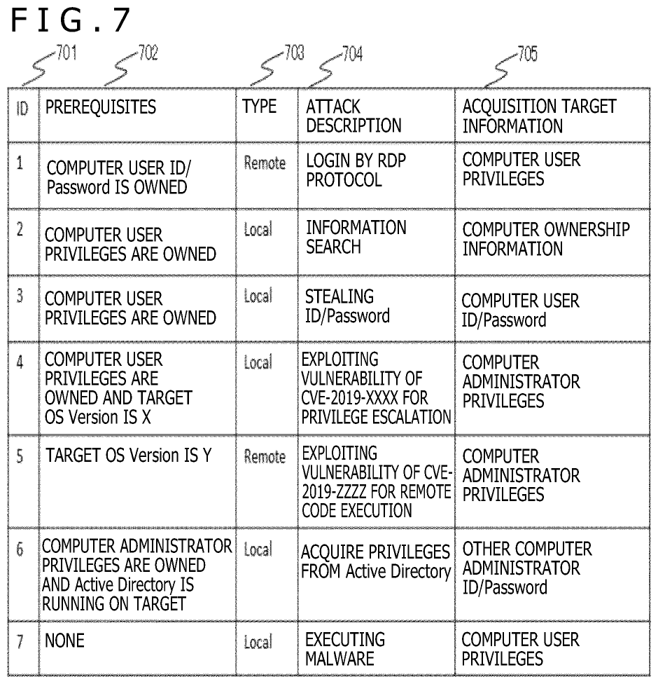

The contents of the attack parts DB 302 will now be described with reference to FIG. 7. The attack parts DB 302 includes an attack parts identifier 701, attack prerequisites 702, an attack type 703, an attack description 704, and acquisition target information 705. The attack parts identifier 701 is an identifier that uniquely defines an attack part. The attack prerequisites 702 are conditions that must be satisfied in order to allow the attack part to make a successful attack. The attack type 703 is information indicating whether the attack target of the attack part is a computer (local) at the starting point or a computer (remote) different from the local computer. The attack description 704 describes an attack that will be made by the attack part. The acquisition target information 705 is information that is acquired when the attack is successfully made by the attack part.

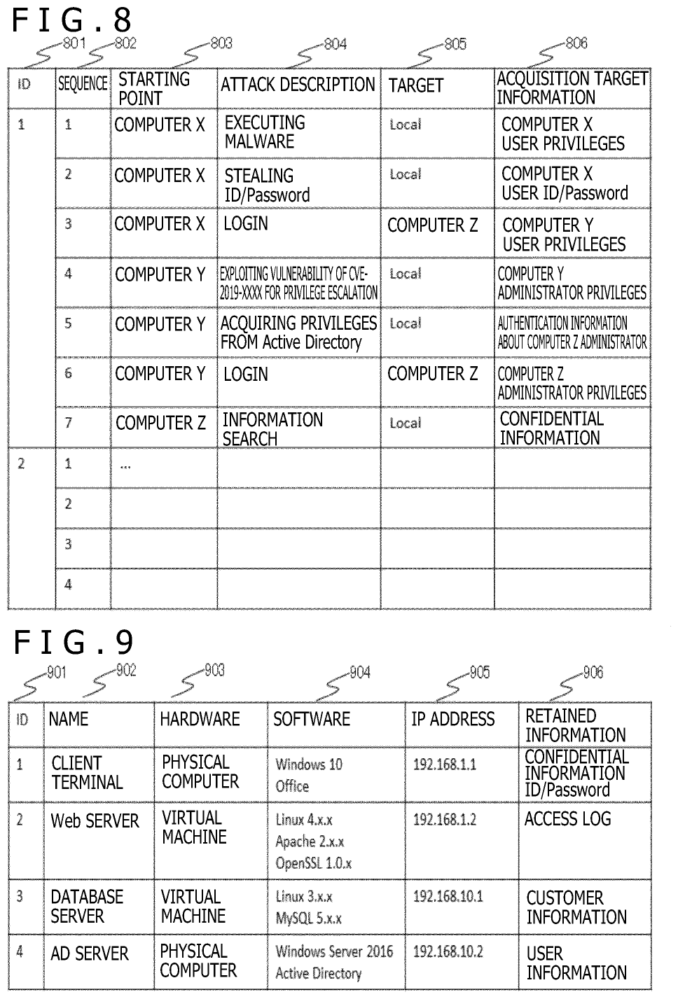

The contents of the scenario DB 303 will now be described with reference to FIG. 8. The scenario DB 303 includes a scenario identifier 801, an intra-scenario sequence 802, an attack starting point 803, an attack description 804, an attack target 805, and acquisition target information 806. The scenario identifier 801 is an identifier that uniquely identifies a scenario. The intra-scenario sequence 802 is information indicating the attack order in which a relevant entry in the scenario identified by the scenario identifier 801 is to be executed. The attack starting point 803 is information about a terminal to be an attack starting point of the relevant entry.

The attack description 804 describes an attack that will be made by the relevant entry. Information about the attack description 704 in the attack parts DB 302 is stored as the attack description 804. In the present embodiment, the attack description 804 describes the details of the attack. Alternatively, however, the attack parts identifier 701 in the attack parts DB 302 may be stored as the attack description 804. More specifically, reference information regarding the attack parts DB 302 may be stored as the attack description 804 without storing any detailed information. The attack target 805 is information about a terminal to be attacked by the relevant entry. In a case where the attack target is a local terminal (the attack type of the attack part is local), the attack target 805 is “Local.” The acquisition target information 806 is information that will be acquired by the attack made by the relevant entry.

The contents of the equipment table in the system configuration DB 304 will now be described with reference to FIG. 9. The equipment table in the system configuration DB 304 includes an equipment ID 901, an equipment name 902, hardware information 903, software information 904, an IP address 905, and retained information 906. The equipment ID 901 is an identifier that uniquely identifies equipment. The equipment name 902 is the name of the equipment. The hardware information 903 is information that describes the hardware including the equipment. The software information 904 is information about software incorporated in the equipment and the version of the software. The software is, for example, Windows 10 (registered trademark), Office, Linux 4.x.x (registered trademark), Apache 2.x.x (registered trademark), OpenSSL 1.0.x (registered trademark), Linux 3.x.x, MySQL 5.x.x (registered trademark), Windows Server 2016, or Active Directory (registered trademark).

The IP address 905 is information about an IP address assigned to the equipment. The retained information 906 is information that is retained by the equipment and can be obtained by acquiring the privileges of the equipment.

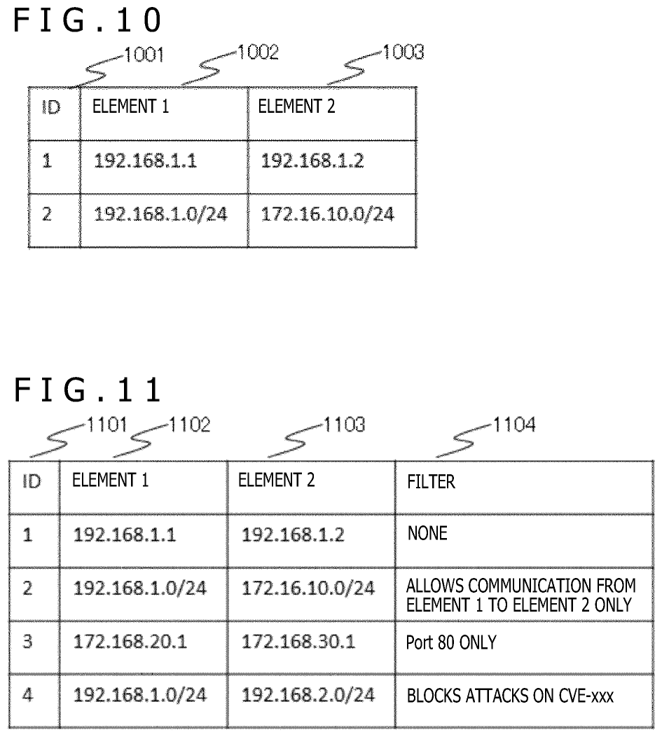

The contents of the network connection table in the system configuration DB 304 will now be described with reference to FIG. 10. The network connection table in the system configuration DB 304 stores connection information indicating IP addresses in the network (network addresses) that are capable of communicating with each other. The network connection table in the system configuration DB 304 includes a connection information ID 1001, a first network element 1002, and a second network element 1003. The connection information ID 1001 is an identifier that uniquely identifies network connection information. The first network element 1002 and the second network element 1003 are IP addresses or network addresses, and used to signify that communication can be established between the IP addresses (network addresses) indicated by the first network element 1002 and the second network element 1003.

The contents of the network filter table in the system configuration DB 304 will now be described with reference to FIG. 11. The network filter table in the system configuration DB 304 contains information about a situation where an IDS (Intrusion Detection System), an FW (FireWall), or other similar device exists between networks to filter some of the communication between the networks. The network filter table in the system configuration DB 304 includes a filter ID 1101, a first network element 1102, a second network element 1103, and a filter description 1104. The filter ID 1101 is an identifier that uniquely identifies network filter information.

The first network element 1102 and the second network element 1103 are IP addresses or network addresses, and used to signify that the communication between the IP addresses (network addresses) indicated by the first network element 1102 and the second network element 1103 is filtered in a manner described by the filter description 1104. The filter description 1104 may describe a white list filter or a black list filter. The white list filter blocks communication that does not match preset conditions for allowing communication. The black list filter allows communication that does not match preset conditions for blocking communication.

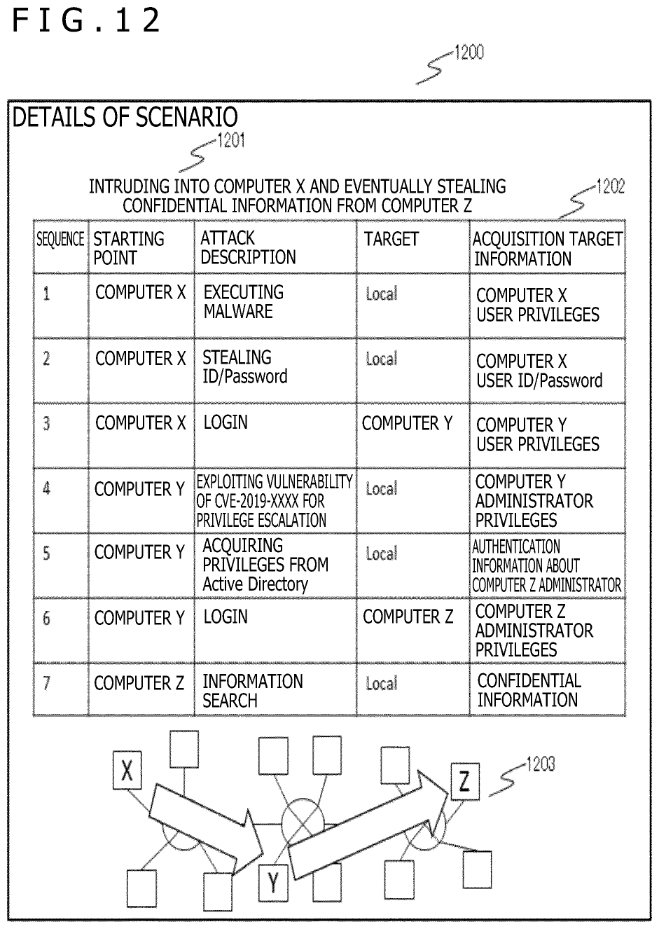

A screen displayed by the scenario display function 305 will now be described with reference to FIG. 12. The scenario display function 305 outputs a scenario display screen 1200 that displays the description of one of scenarios stored in the scenario DB 303. Which of the scenarios stored in the scenario DB 303 is to be displayed is determined, for example, according to an instruction from the user. The scenario display screen 1200 includes a scenario summary 1201, a scenario description 1202, and a scenario display 1203 on a network map. The scenario display function 305 acquires information from the attack parts DB 302, the scenario DB 303, and the system configuration DB 304, and renders the scenario summary 1201, the scenario description 1202, and the scenario display 1203.

In the scenario description 1202, the descriptions of a scenario to be displayed are listed in chronological order. In the example of FIG. 12, the descriptions of the scenario are listed as indicated below.

In sequence 1, an attack described as “Executing malware” is made on a local computer (computer X itself) with a starting point set at computer X, and computer X user privileges are acquired as acquisition target information.

Next, in sequence 2, an attack described as “Stealing ID/password” is made on the local computer (computer X itself) with the starting point set at computer X, and computer X user ID and password are acquired as the acquisition target information.

Next, in sequence 3, an attack described as “Login” is made on computer Y with the starting point set at computer X, and computer Y user privileges are acquired as the acquisition target information.

Next, in sequence 4, an attack described as “Exploiting vulnerability of CVE-2019-XXXX for privilege escalation” is made on a local computer (computer Y itself) with the starting point set at computer Y, and computer Y administrator privileges are acquired as the acquisition target information.

Next, in sequence 5, an attack described as “Acquiring privileges from Active Directory” is made on the local computer (computer Y itself) with the starting point set at computer Y, and the authentication information about a computer Z administrator is acquired as the acquisition target information.

Next, in sequence 6, an attack described as “Login” is made on computer Z with the starting point set at computer Y, and computer Z administrator privileges are acquired as the acquisition target information. Next, in sequence 7, an attack described as “Information search” is made on a local computer (computer Z itself) with the starting point set at computer Z, and confidential information is acquired as the acquisition target information. The scenario for intruding into computer X and eventually stealing the confidential information from computer Z is expressed as described above.

### Second Embodiment

The incident scenario generation device 101 according to the first embodiment specifies an attack part that is to be the starting point of a scenario, and then adds attackable attack parts to expand the scenario. Meanwhile, for purposes of scenario generation, an alternative may be to use a method of defining a final result and expanding a scenario by deriving a process leading to achieve the defined final result. A second embodiment of the present invention is configured such that the above-mentioned method is used for scenario generation.

In the second embodiment, the flow of processing performed by the scenario generation function 301 is a reversal of the corresponding flow of processing in the first embodiment. More specifically, the second embodiment first defines an ultimate goal (e.g., acquisition target information), picks up attack parts involved before ultimate goal achievement, acquires information about attackable terminals to derive a point immediately before the ultimate goal, and repeats the above-mentioned steps to generate a scenario.

A configuration formed according to the second embodiment is able to generate a scenario from a final event, and is utilizable to create a scenario for cyber attack response training.

In the second embodiment, too, the incident scenario generation device 101 has the scenario display function 305, as is the case with the first embodiment. The scenario display function 305 displays the screen depicted in FIG. 12. The scenario display function 305 outputs the scenario display screen 1200, which displays the description of one of scenarios stored in the scenario DB 303. Which of the scenarios stored in the scenario DB 303 is to be displayed is determined, for example, according to an instruction from the user.

The scenario display screen 1200 includes the scenario summary 1201, the scenario description 1202, and the scenario display 1203 on the network map. The scenario display function 305 acquires information from the attack parts DB 302, the scenario DB 303, and the system configuration DB 304, and renders the scenario summary 1201, the scenario description 1202, and the scenario display 1203.

In the scenario description 1202, the descriptions of a scenario to be displayed are listed in chronological order. In the example of FIG. 12, the descriptions of the scenario are listed as indicated below.

In sequence 1, an attack described as “Executing malware” is made on a local computer (computer X itself) with a starting point set at computer X, and computer X user privileges are acquired as acquisition target information.

Next, in sequence 2, an attack described as “Stealing ID/password” is made on the local computer (computer X itself) with the starting point set at computer X, and computer X user ID and password are acquired as the acquisition target information.

Next, in sequence 3, an attack described as “Login” is made on computer Y with the starting point set at computer X, and computer Y user privileges are acquired as the acquisition target information.

Next, in sequence 4, an attack described as “Exploiting vulnerability of CVE-2019-XXXX for privilege escalation” is made on a local computer (computer Y itself) with the starting point set at computer Y, and computer Y administrator privileges are acquired as the acquisition target information.

Next, in sequence 5, an attack described as “Acquiring privileges from Active Directory” is made on the local computer (computer Y itself) with the starting point set at computer Y, and the authentication information about a computer Z administrator is acquired as the acquisition target information.

Next, in sequence 6, an attack described as “Login” is made on computer Z with the starting point set at computer Y, and computer Z administrator privileges are acquired as the acquisition target information.

Next, in sequence 7, an attack described as “Information search” is made on a local computer (computer Z itself) with the starting point set at computer Z, and confidential information is acquired as the acquisition target information. The scenario for intruding into computer X and eventually stealing the confidential information from computer Z is expressed as described above.

### Third Embodiment

In the first and second embodiments, an incident scenario is generated by a single device. However, an alternative configuration may be adopted so that the scenario generation function 301, the attack parts DB 302, the scenario DB 303, the system configuration DB 304, and the scenario display function 305, which are included in the incident scenario generation device 101, are respectively implemented as the function of a single device and connected with each other through a network.

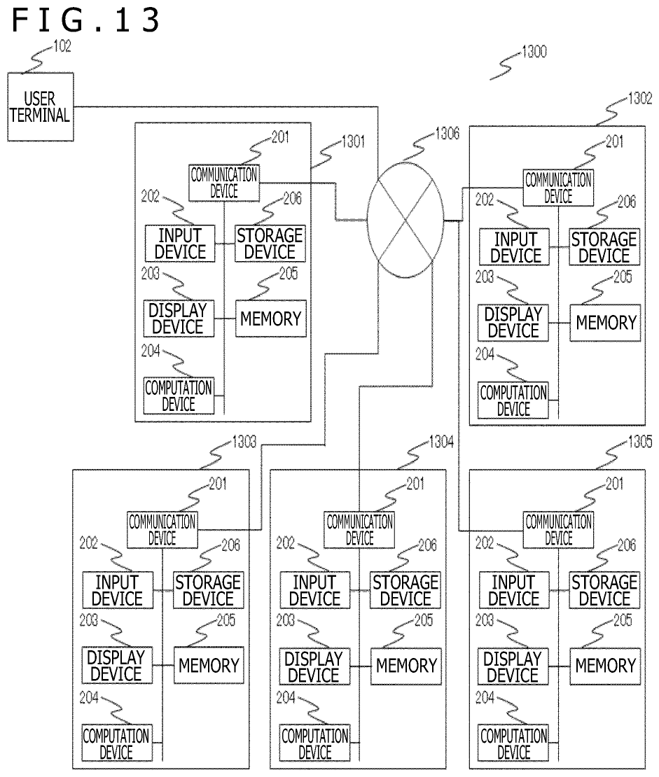

FIG. 13 depicts a configuration of an incident scenario generation system 1300 according to a third embodiment of the present invention. The incident scenario generation system 1300 is a network system in which a plurality of devices are connected to each other through a network, and is configured to include a scenario generation device 1301, an attack parts DB storage device 1302, a scenario DB storage device 1303, a system configuration DB storage device 1304, a scenario display device 1305, and a network 1306 that connects the above-mentioned devices to each other.

The scenario generation device 1301 includes the communication device 201, the input device 202, the display device 203, the computation device 204, the memory 205, and the storage device 206. The communication device 201 is a network interface such as a network card. The communication device 201 receives data from another device through a network 1036, and transmits the received data to the computation device 204. Subsequently, the communication device 201 transmits data generated by the computation device 204 to another device through the network 1036.

The input device 202 is a keyboard, a mouse, or other similar device, and configured to receive information inputted by the user. The display device 203 is an LCD (Liquid Crystal Display) or other similar device, and configured to output information to the administrator.

The storage device 206 is a hard disk or other similar device, and configured to store, for example, programs to be executed by the computation device 204 and data to be used by the computation device 204. The memory 205 is a storage area from which, for example, data is temporarily read.

The computation device 204 executes the programs stored in the storage device 206 to control the other devices included in a sorting device 105. The computation device 204 controls the input device 202 and the display device 203, receives data inputted from the input device 202, and outputs data to the display device 203. The programs stored in the storage device 206 are loaded into the memory 205 from the storage device 206 and executed in the memory 205 by the computation device 204.

The computation device 204 reads the programs from the storage device 206. However, as an alternative example, the computation device 204 may read the programs from an optical recording medium such as a CD or a DVD, a magneto-optical recording medium such as an MO, a tape medium, a magnetic recording medium, or other recording medium such as a semiconductor memory. Further, as another alternative example, the computation device 204 may read the programs from another device through a communication medium. The communication medium is a network or a digital signal or carrier wave that propagates the programs.

Furthermore, the programs may be stored in the storage device 206 from a storage device in an external device through a network or through a portable storage medium.

The hardware configurations of the attack parts DB storage device 1302, scenario DB storage device 1303, system configuration DB storage device 1304, and scenario display device 1305 are identical to the hardware configuration of the scenario generation device 1301. The hardware configurations of the individual devices are not limited to the above-mentioned hardware configuration, and may vary from each other within a range within which the functions of the individual devices are implementable.

The foregoing embodiments are able to clarify the route of a cyber attack on an information system and determine the range of possible influence exerted by the cyber attack.

Further, the foregoing embodiments are able to select the occurrence of a final event, derive the route of a cyber attack causing the final event, and thus utilize the derived cyber attack route for establishing a defense against a predicted cyber attack and creating a scenario for cyber attack response training.

While the above disclosure has been described in terms of typical embodiments, persons skilled in the art will appreciate that various changes and modifications may be made in form and detail without departing from the scope and spirit of the disclosure.

### DESCRIPTION OF REFERENCE NUMERALS

101: Incident scenario generation device
301: Scenario generation function
302: Attack parts DB
303: Scenario DB
304: System configuration DB
305: Scenario display function
1300: Incident scenario generation system
1301: Scenario generation device
1302: Attack parts DB storage device
1303: Scenario DB storage device
1304: System configuration DB storage device
1305: Scenario display device
1306: Network

1. An incident scenario generation device including a storage device and a computation device, and generating an incident scenario that indicates how an attack progresses in relation to an information system, wherein
the storage device includes an attack parts database and a system configuration database, the attack parts database storing attack parts information, the system configuration database storing system configuration information about the information system, and
the computation device generates the incident scenario according to the attack parts information stored in the attack parts database and to the system configuration information stored in the system configuration database.

2. The incident scenario generation device according to claim 1, wherein
the computation device
regards a first attack as a starting point and defines a first attack description of the first attack and a first attack target on a basis of the attack parts information and the system configuration information, and
regards the first attack target as a starting point, defines a second attack description of a second attack and a second attack target, and thus sequentially adds the attack parts information about parts attackable by the attack.

3. The incident scenario generation device according to claim 1, wherein
the computation device
defines a first attack description and a first attack target that are adapted for reaching a final starting point, on a basis of the attack parts information and the system configuration information, and
regards the first attack target as a starting point, defines a second attack description and a second attack target that are adapted for reaching the final starting point, and thus sequentially adds the attack parts information about parts attackable by the attack.

4. The incident scenario generation device according to claim 1, wherein
the system configuration database stores connection information and network filter information as the system configuration information, the connection information defining an IP address that permits communication via a network, the network filter information indicating that communication is partly filtered.

5. The incident scenario generation device according to claim 4, wherein
the computation device uses the network filter information to narrow down the attack that is deliverable.

6. The incident scenario generation device according to claim 1, wherein
the attack parts database stores, as the attack parts information, attack prerequisites, an attack type, an attack description, and information that is obtained when the attack is successfully made, the attack prerequisites defining conditions that must be satisfied in order to successfully make the attack, the attack type being information indicating whether an attack target is a terminal at a starting point or another terminal, the attack description describing the attack.

7. The incident scenario generation device according to claim 6, wherein
the computation device extracts, as an attack candidate, the attack satisfying the attack prerequisites.

8. The incident scenario generation device according to claim 1, wherein
the storage device further includes a scenario database that stores the incident scenario,
the scenario database stores, as the incident scenario, an attack starting point, an attack description, and an attack target, the attack starting point representing information about a terminal to be the starting point of the attack, the attack description describing the attack to be made, the attack target indicating the target of the attack to be made, and
the incident scenario stored in the scenario database is to be displayed on the screen of a terminal.

9. The incident scenario generation device according to claim 8, wherein
the screen of the terminal displays a summary of the incident scenario, a description of the incident scenario, and the incident scenario on a network map.

10. An incident scenario generation system that is formed by connecting, through a network, an incident scenario generation device, an attack parts database storage device, and a system configuration database storage device to each other, wherein
the attack parts database storage device stores an attack parts database for storing attack parts information,
the system configuration database storage device stores a system configuration database for storing system configuration information about an information system, and
the incident scenario generation device generates an incident scenario according to the attack parts information stored in the attack parts database and to the system configuration information stored in the system configuration database, the incident scenario indicating how an attack progresses in relation to the information system.

11. The incident scenario generation system according to claim 10, wherein
the incident scenario generation system is further connected to a scenario display device and a scenario database storage device through a network,
the scenario database storage device stores a scenario database for storing the incident scenario,
the scenario database stores, as the incident scenario, an attack starting point, an attack description, and an attack target, the attack starting point representing information about a terminal to be the starting point of the attack, the attack description describing the attack to be made, the attack target indicating the target of the attack to be made, and
the scenario display device displays the incident scenario stored in the scenario database.

12. The incident scenario generation system according to claim 11, wherein
the scenario display device displays a summary of the incident scenario, a description of the incident scenario, and the incident scenario on a network map.
